(19) United States
(12) Patent Application Publication
(10) Pub. No.: US 2024/0000643 A1
(43) Pub. Date: Jan. 4, 2024

(54) STABLE SUPPORT MECHANISM, AND POSTURE TRANSITION ASSIST APPARATUS, CHAIR, AND MOBILE APPARATUS THAT USE THE SAME

(71) Applicant: University of Tsukuba, Ibaraki (JP)

(72) Inventors: Kenji SUZUKI, Ibaraki (JP); Yosuke EGUCHI, Ibaraki (JP)

(21) Appl. No.: 18/253,181

(22) PCT Filed: Nov. 10, 2021
(86) PCT No.: PCT/JP2021/041379

§ 371 Date: May 16, 2023

(30) Foreign Application Priority Data
Nov. 20, 2020 (JP) 2020-193849

(51) Int. Cl. A61G 5/14

(52) U.S. Cl. CPC A61G 5/14; A61G 2200/34

(57) ABSTRACT

To stably support a user before and after posture transition between a standing position and a sitting position by suppressing forward and backward movement of a position of the center of gravity of a user without power supply with a simple configuration. A stable support mechanism includes a base, a support structure mounted on the base, the support structure being configured to be capable of translational movement along a first axis in a plane horizontal to the base, the support structure being configured to be capable of changing a posture between a first position and a second position in a plane perpendicular to the base, and a link having a fixed length, one end of the link being connected to the base, the other end of the link being connected to the support structure, the link being configured to guide the support structure in a direction along the first axis along with changing the posture of the support structure.

### TECHNICAL FIELD

The present invention relates to a stable support mechanism, and a posture transition assist apparatus, a chair, and a mobile apparatus that use the same, and more particularly, to a stable support mechanism that suppresses forward and backward movement of a position of the center of gravity of a user and an application thereof.

### BACKGROUND ART

In accordance with shifting of body weight of an upper body, a posture-variable standing type mobile apparatus provided with a mechanism, which supports a motion to transition from a sitting position to a standing position or from a standing position to a sitting position, is known (for example, see Patent Document 1). As a configuration of a chair to which a sitting and standing assist function is imparted, a configuration in which a sitting seat rotates to support the buttocks of a user up to a high standing position is known (for example, see Patent Document 2). In any configuration, ground contact positions of the feet of the user are the same at the time of sitting-down and at the time of standing-up.

A configuration in which a support structure slides forward when a care-receiver places their arms on an arm placement portion of a transfer apparatus and grips a grip portion to move from a chair to the transfer apparatus is known (for example, see Patent Document 3). In this configuration, the care-receiver moves from the chair to the transfer apparatus in a half-sitting state or a slouching state. A configuration in which a seat portion is vertically erected with respect to a mounting table by an electrically-driven linear actuator to move the center of gravity of a chair in a vertical direction is known (for example, see Patent Document 4).

### RELATED-ART DOCUMENTS

### Patent Document

Patent Document 1: Japanese Patent No. 6377888
Patent Document 2: Japanese Unexamined Patent Application No. 2019-97575
Patent Document 3: Japanese Patent No. 6617997
Patent Document 4: WO 2016/001451

### SUMMARY OF INVENTION

### Problem to be Solved by the Invention

The standing and sitting motions of a person are motions of transitioning between two states of a sitting posture in which the center of gravity is mainly carried by the buttocks and a standing posture in which the center of gravity is carried by the soles. The position of the center of gravity of the human body moves forward by the standing motion and moves backward by the sitting motion. Forward and backward movement of the position of the center of gravity of the human body is not preferable for a configuration that requires stability in both standing and sitting postures, including chairs for work, chairs for standing practice, wheelchairs having a standing-up function, and the like. In a wheelchair having a standing-up function or a chair for rehabilitation, the size of a structure in a front-back direction is increased, and thus, stability in both the standing and sitting postures is ensured. When a typical chair is used, a user generally needs to move the chair forward and backward, and thus, the center of gravity is smoothly moved when the user is to stand up or to sit down. Not only the stability in the standing posture and the sitting posture but also the stability during posture transition such as a standing motion and a sitting motion are required. It is desired to achieve a configuration for stabilizing a posture with a simple configuration without power supply.

An object of the present invention is to stably support a user during posture transition and before and after the posture transition by suppressing forward and backward movement of the position of the center of gravity of the user with a simple configuration requiring no power supply.

### Means to Solve the Problem

In one aspect of the present invention, a stable support mechanism includes
a base,
a support structure mounted on the base, the support structure being configured to be capable of translational movement along a first axis in a plane horizontal to the base, the support structure being configured to be capable of changing a posture between a first position and a second position in a plane perpendicular to the base, and
a link having a fixed length, one end of the link being connected to the base, the other end of the link being connected to the support structure, the link being configured to guide the support structure in a direction along the first axis along with changing the posture of the support structure.

### Effects of Invention

Forward and backward movement of a position of the center of gravity of a user is suppressed, and support stability of the user by the apparatus is maintained during posture transition and before and after the posture transition.

### BRIEF DESCRIPTION OF DRAWINGS

FIG. 1 is a diagram for explaining movement of a position of the center of gravity of a person caused by a general standing motion and a general sitting motion.

FIG. 2 is a diagram illustrating movement of a position of the center of gravity of a user with a stable support mechanism according to the embodiment.

FIG. 3A is a side view of the stable support mechanism in a sitting state.

FIG. 3B is a side view of the stable support mechanism in a standing state.

FIG. 4 is a diagram of calculation results for considering a length of a link.

FIG. 5A is a side view of the stable support mechanism in a sitting state in a modification.

FIG. 5B is a side view of the stable support mechanism in a standing state in the modification.

FIG. 6A is a side view of a posture transition assist apparatus including the stable support mechanism in a sitting state.

FIG. 6B is a side view of the posture transition assist apparatus including the stable support mechanism in a standing state.

FIG. 6C is a diagram of the posture transition assist apparatus in FIG. 6A viewed obliquely from a back side.

FIG. 7A is a diagram illustrating a sitting state when the stable support mechanism is applied to a chair.

FIG. 7B is a diagram illustrating a standing state when the stable support mechanism is applied to the chair.

FIG. 8 is a top view of a seat to be used for the chair.

FIG. 9A is a diagram illustrating a sitting state of a mobile apparatus to which the posture transition assist apparatus including the stable support mechanism is applied.

FIG. 9B is a diagram illustrating a standing state of the mobile apparatus to which the posture transition assist apparatus including the stable support mechanism is applied.

### MODE FOR CARRYING THE INVENTION

Hereinafter, one or more embodiments of the present invention will be described with reference to the accompanying drawings. In the embodiment, when a user transitions from a sitting position to a standing position or from a standing position to a sitting position, forward and backward movement of a position of the center of gravity of the user is suppressed and the user is stably supported. In the following description, a person who uses a stable support mechanism according to the embodiment or an application example thereof is referred to as a “user”, and a human being in general as a living thing is referred to as a “person”. Additionally, transition of a user from a sitting position to a standing position or from a standing position to a sitting position is referred to as “posture transition”. Changing the posture or mode of a constituent element of the stable support mechanism in conjunction with the posture transition of the user is referred to as “posture change”. Here, the support stability includes not only stability in a specific posture such as a standing posture or a sitting posture but also stability during posture transition. In the embodiment, a configuration is adopted in which positions of the feet are translationally moved in the front-back direction when the user stands up and sits down, and the support stability of the body of the user is maintained during posture transition and before and after the posture transition with a limited occupied area, which suppresses forward and backward movement of the position of the center of gravity of the user.

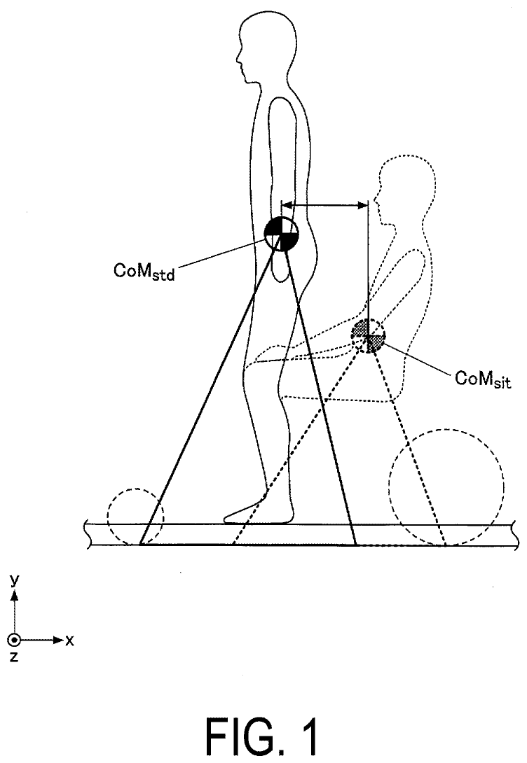

FIG. 1 is a diagram for explaining movement of a position of the center of gravity of a person by a general standing motion and a general sitting motion. When positions of the feet are fixed, the center of gravity of the person moves forward and obliquely upward in transitioning from a sitting position to a standing position. The center of gravity CoMsit at the sitting position is at a relatively low position behind the positions of the feet. The center of gravity CoMstd at the standing position is at a relatively high position above the feet.

The base of a triangle drawn by using each of solid and dotted lines in FIG. 1 corresponds to a support polygon where a support structure of the apparatus is formed on the ground. In principle, as long as a position of the center of gravity CoM is projected onto the ground in a vertical direction and remains within the support polygon (corresponding to the base of the triangle in FIG. 1), the stability of a user and the apparatus supporting the user is ensured. However, in an actual environment, not only does the position of the center of gravity CoM fluctuate as a user takes various postures, but also the position of the center of gravity CoM and an angle of projection onto the ground fluctuate because the ground is not horizontal, or acceleration/deceleration occurs in the case of a mobile device. The support polygon on the ground forms a surface because the support polygon is formed with the above fluctuation under assumed conditions of use reflected. When a support region (support polygon, for example, rectangular region) stably supporting the center of gravity CoMsit at the sitting position is defined as the base of the triangle (dotted line), a support region (support polygon, for example, rectangular region) stably supporting the center of gravity CoMstd at the standing position corresponds to the base of the triangle (solid line), and front and back positions of the support regions required to stably support the user change.

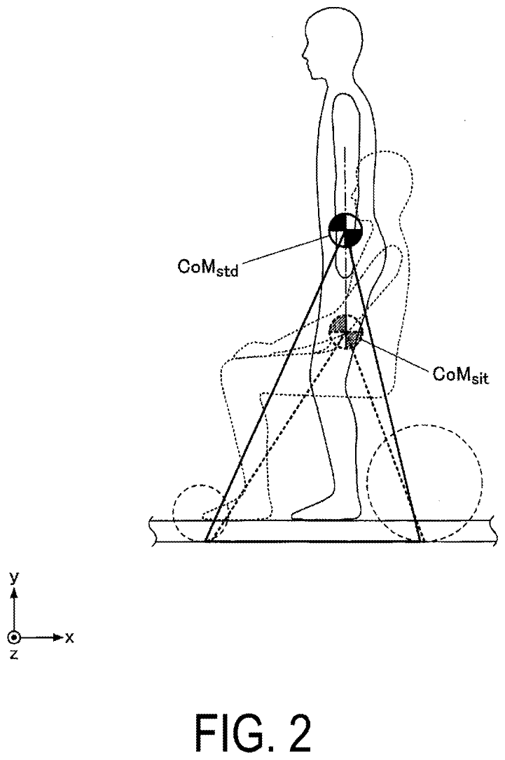

FIG. 2 is a diagram illustrating movement of a position of the center of gravity of a user with the stable support mechanism according to the embodiment. A position of the center of gravity CoMsit at the sitting position and a position of the center of gravity CoMstd at the standing position do not substantially change in the front-back direction along an x-axis, but exclusively move in an up-down direction. The positions in the front-back direction of the support region of a bottom surface that stably supports the center of gravity CoMsit at the sitting position and the support region of the bottom surface that stably supports the center of gravity CoMstd at the standing position hardly change.

It is necessary to provide a mechanism for changing positions of the feet when standing up, and thus, the forward and backward movement of the position of the center of gravity between the sitting position and the standing position can be suppressed. Based on this basic concept, the inventors have conceived an idea of the stable support mechanism according to the embodiment. In the configuration described in Patent Document 4, since a separate actuator that drives a slide link for horizontal movement is controlled in conjunction with a linear actuator for driving a seat portion, the configuration is complicated and requires electric power. On the other hand, the embodiment proposes a stable support mechanism that has a simple structure and that does not require electric power.

When the positions of the feet are fixed as illustrated in FIG. 1, the position of the center of gravity moves forward and backward (that is, in the horizontal direction) according to motions of standing up and sitting down, and the support region of the bottom surface stably supporting the center of gravity also horizontally moves along with the movement. When a relative change of the support region is made small, the support structure can be made small. In particular, almost eliminating a forward change in position of the center of gravity of the user during the standing motion reduces a sense of instability when the standing posture is reached in the final phase of the standing motion.

When the stable support mechanism of the embodiment is applied to a chair, a power source is not required, and the chair does not need to be largely pulled when standing up in conference or the like, for example. Also, the instability when standing up without changing the positions of the feet is reduced. When the stable support mechanism is applied to a mobile apparatus, a size of a bottom surface of a mobile body can be reduced. Further, a fluctuation in ground contact force of each wheel is suppressed, and stable travel can be performed in both the standing posture and the sitting posture. When the stable support mechanism is applied to a posture transition assist apparatus for standing practice or rehabilitation, in addition to reduction of an area occupied by the apparatus on a floor, a sense of instability due to suppression of urging in an obliquely forward direction during the standing motion is reduced.

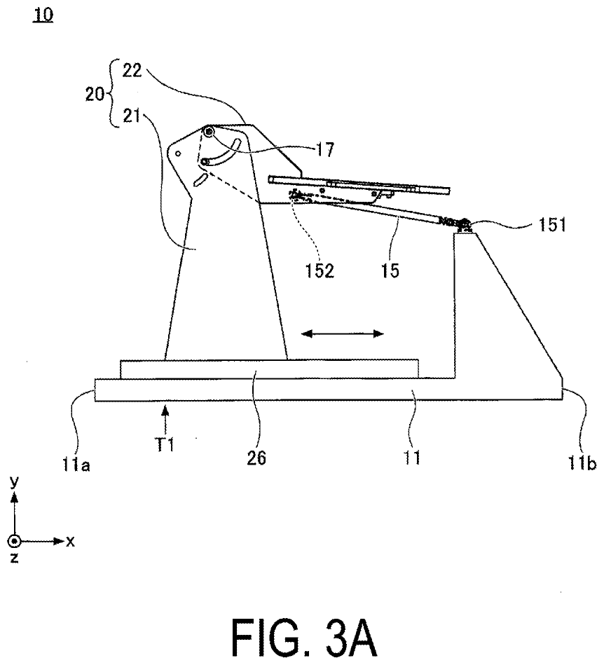

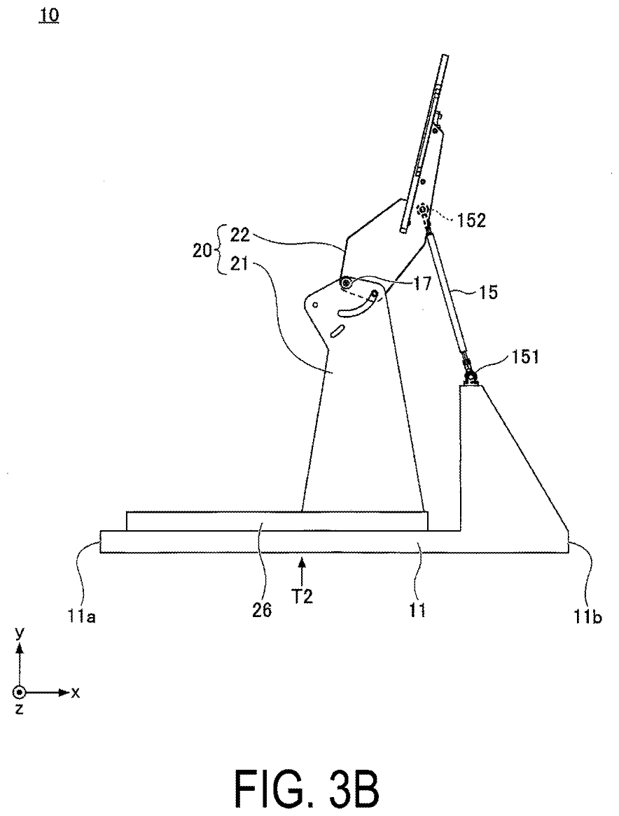

FIG. 3A and FIG. 3B are diagrams of a basic configuration of a stable support mechanism 10 according to the embodiment. FIG. 3A is a side view of a first state corresponding to a sitting position, and FIG. 3B is a side view of a second state corresponding to a standing position. As spatial axes of FIG. 3A and FIG. 3B, the front-back direction of the stable support mechanism 10 is defined as an x-axis, and the height direction is defined as a y-axis. The stable support mechanism 10 includes a base 11, a support structure 20 mounted on the base 11, and a link 15 connecting one point on the base 11 and one point on the support structure 20. A unit configured to suppress movement of the center of gravity in the horizontal direction along with a standing motion and a sitting motion of a user is mainly implemented by the support structure 20 and the link 15. A length of the link 15 is fixed, and a mechanism configured to change the length of the link 15 is not required. The support structure 20 is capable of translational movement along the x-axis in a plane horizontal to the base 11, and is capable of posture change between a sitting position (first position) and a standing position (second position) in an xy plane perpendicular to the base 11.

One end portion 151 of the link 15 is connected to the base 11, and the other end portion 152 is connected to the support structure 20. The link 15 guides the support structure 20 in a direction along the x-axis along with the posture change of the support structure 20.

A mobile member 26 is provided between a front end portion 11a and a back end portion 11b of the base 11, which causes the support structure 20 to translationally move along the x-axis. The support structure 20 includes a first portion 21 that translationally moves by the mobile member 26 but does not change its posture, and a second portion 22 that is rotatably connected to the first portion 21 and changes its posture. The end portion 152 of the link 15 is connected to the second portion 22 that changes its posture. When the posture of the second portion 22 is changed counterclockwise or in a +y direction, the position of the end portion 152 is changed. Since the other end portion 151 is fixed to the base 11 and does not move, the first portion 21 of the support structure 20 is guided on the mobile member 26 in a +x direction by the change in position of the end portion 152.

The second portion 22 of the support structure 20 is in conjunction with the standing motion or the sitting motion of the user. By following the posture transition of the user, the second portion 22 changes its posture from the first position substantially horizontal or close to horizontal to an installation surface of the stable support mechanism 10 to the second position substantially perpendicular or close to perpendicular to the installation surface. To be more specific, when the second portion 22 of the support structure 20 is at the first position, the first portion 21 is at a translational position T1 in the x-axis direction. This state is referred to as a “first state”. When the second portion 22 of the support structure 20 rises up from the installation surface to the second position that is substantially perpendicular to the installation surface, the first portion 21 is at a translational position T2 that is positioned behind the translational position T1. This state is referred to as a “second state”.

At the first position where the second portion 22 is substantially horizontal or close to horizontal to the installation surface, the second portion 22 does not need to be strictly parallel to the installation surface and a range of ±40 degrees from the horizontal is included. Similarly, at the second position where the second portion 22 is substantially perpendicular or close to perpendicular to the installation surface, the second portion 22 does not need to rise up at an angle of exactly 90 degrees from the installation surface, and a range of ±40 degrees from the perpendicular is included. Hereinafter, even when the first position is referred to as a “horizontal position” and the second position is referred to as a “vertical position” for the sake of convenience, each of the positions includes a range of ±40 degrees from the horizontal or the vertical.

In addition to the first state and the second state, the stable support mechanism 10 has a third state that transitions between the first state and the second state. In the third state, the second portion 22 moves from the first position (horizontal position) to the second position (vertical position), and the first portion 21 moves from the translational position T1 to the translational position T2 along the x-axis. Alternatively, the second portion 22 moves from the second position (vertical position) to the first position (horizontal position), and the first portion 21 moves from the translational position T2 to the translational position T1 along the x-axis.

The mobile member 26 may have any configuration as long as the support structure 20 can be moved in the x-axis direction without power supply. A slide mechanism in which a slide rail and a slider are combined may be used, or a protrusion with low friction that is slidably fitted into a groove formed in the base 11 may be provided on the bottom surface of the support structure 20. The mobile member 26 may be combined with any transmission mechanism such as a belt, a wire, a chain, a gear, or the like capable of converting a change in position of the end portion 152 of the link 15 into translational movement in the horizontal direction.

As a feature of the configuration of the embodiment, when the user sits down, that is, when the stable support mechanism 10 is shifted from the state illustrated in FIG. 3B to the state illustrated in FIG. 3A, a clockwise load is applied to a rotation shaft 17 by a force tilting the buttocks of the user obliquely backward, and at the same time, a forward force, that is, a force toward the −x direction acts on the first portion 21 of the support structure 20. Assuming that a frictional force of the mobile member 26 is ideally zero, the first portion 21 moves in the −x direction even without the link 15, but any frictional force actually acts. Also, without the link 15, control of a translational speed and a movement range of the first portion 21 becomes difficult. Providing the link 15 allows the first portion 21 to be stably guided in the direction along the x-axis according to the posture change of the second portion 22.

When the user stands up, that is, when the stable support mechanism 10 shifts from the state illustrated in FIG. 3A to the state illustrated in FIG. 3B, the upper body of the user tilts forward and a counterclockwise force is applied to the rotation shaft 17. Assuming that a frictional force of the mobile member 26 is ideally zero, the first portion 21 moves in the +x direction even without the link 15. In actual use, the link 15 guides the first portion 21 of the support structure 20 in the +x direction at a suitable speed by a suitable distance.

Rapid movement of the first portion 21 is suppressed by the link 15, and the user can stand up and sit down with a stable motion. According to the configurations in FIG. 3A and FIG. 3B, the movement of the center of gravity in the front-back direction of the user is suppressed without power supply. The motion of the posture transition by the user, in particular, an urging force in the final phase of the transition motion is suppressed to stabilize the posture, and the user does not have a sense of being thrown forward.

### <Link Design>

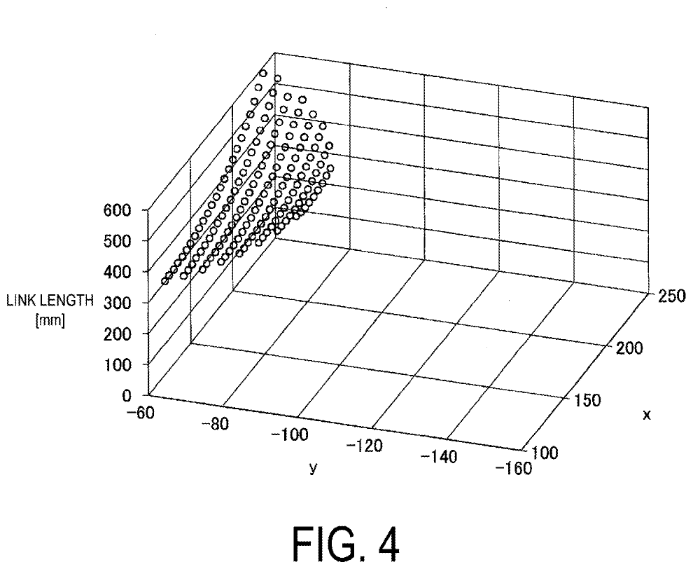

FIG. 4 is a diagram of calculation results for considering a length of the link 15 to be used in the stable support mechanism 10. A length of the link 15 having a fixed length in an axial direction and a position of one end portion 152 of the link 15 are obtained by numerical calculation, and thus, a desired amount of translational movement is obtained in conjunction with posture transition of a user. The x-axis and the y-axis in FIG. 4 are represented by a coordinate system when the second portion 22 is at the first position (that is, a sitting position or horizontal position) as illustrated in FIG. 3A. The x-axis represents a position of the end portion 152 of the link 15 in the x-axis direction when the position of the rotation shaft 17 in FIG. 3A is defined as the origin, and the y-axis represents a position of the end portion 152 of the link 15 in a height direction when the rotation shaft 17 is defined as the origin. The z-axis in FIG. 4 represents a length (mm) of the link 15.

The desired amount of translational movement along the x-axis is set to 300 mm, and then, calculation is performed. The link 15 is designed with an optimum length, and thus, the second portion 22 of the support structure is driven without power supply. The end portion 152 of the link 15 is fixed relatively close to the rotation shaft 17, and thus, the length of the link 15 can be made as short as possible, for example, set to 400 mm. When the length of the link 15 is about 600 mm, the end portion 152 of the link 15 can be relatively separated from the rotation shaft 17 in both the height direction (y direction) and the translation direction (x direction).

### <Modifications to Stable Support Mechanism>

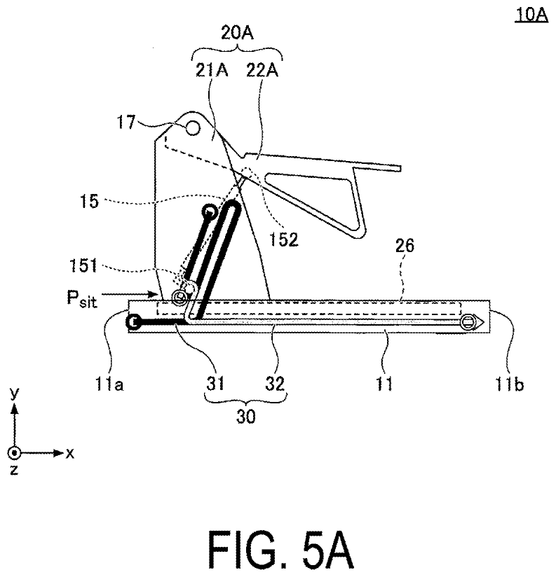

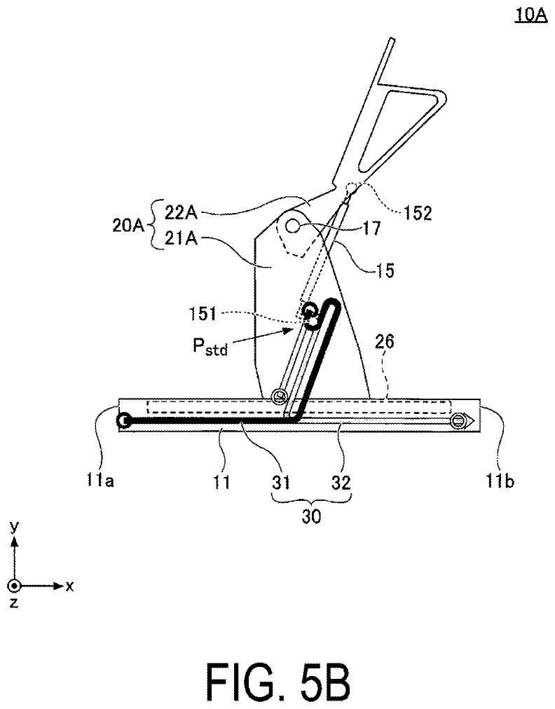

FIG. 5A and FIG. 5B illustrate a stable support mechanism 10A in a modification. In the stable support mechanism 10A, the posture change of the second portion 22A of the support structure 20A is transmitted to a first transmission unit 31 and a second transmission unit 32 by the link 15 having a fixed length, and is converted into translational movement of the support structure 20A along the x-axis.

The support structure 20A is made movable along the mobile member 26 by a transmission unit 30 including the first transmission unit 31 and the second transmission unit 32. The first transmission unit 31 and the second transmission unit 32 are freely selected members capable of transmitting the posture change of the second portion 22A of the support structure 20A to the translational movement of the support structure 20A, and a belt, a wire, a chain, or the like may be used.

In FIG. 5A and FIG. 5B, one end portion 151 of the link 15 is connected to the base 11 through the transmission unit 30, and the other end portion 152 is fixed to the second portion 22A of the support structure 20A. When the second portion 22A rotates around the rotation shaft 17, the position of the end portion 152 of the link 15 changes. When the position of the end portion 152 changes, the end portion 151 moves between a sitting position Psit and a standing position Pstd.

The sitting position Psit is a position at which the second transmission unit 32 of the transmission unit 30 is fixed or in the vicinity of the position. The standing position Pstd is a position at which the first transmission unit 31 of the transmission unit 30 is fixed or in the vicinity of the position.

One end of the first transmission unit 31 is fixed to the front end portion 11a side of the base 11, and the other end thereof is fixed to the standing position Pstd of the first portion 21A or the vicinity of the standing position Pstd. One end of the second transmission unit 32 is fixed to the back end portion 11b side of the base 11, and the other end thereof is fixed to the sitting position Psit of the first portion 21A or the vicinity of the sitting position Psit.

In the sitting state in FIG. 5A, the end portion 151 of the link 15 is in the vicinity of Psit and the first portion 21A of the support structure 20A is positioned at the front end portion 11a side of the base 11. The first transmission unit 31 is folded in the vicinity of the sitting position Psit, and has a longer region accommodated in a routing portion having a zigzag shape, and a shorter region extending along the base 11. On the other hand, the second transmission unit 32 has a longer region extending along the base 11.

In the standing state in FIG. 5B, the end portion 151 of the link 15 is in the vicinity of Pstd and the first portion 21A of the support structure 20A moves toward the back end portion 11b side of the base 11. The second transmission unit 32 is folded in the vicinity of the standing position Pstd, and has a longer region accommodated in a routing portion having a zigzag shape and a shorter region extending along the base 11. On the other hand, the first transmission unit 31 includes a longer region extending along the base 11.

The position of the end portion 152 of the link 15 moves according to the posture change of the second portion 22A of the support structure 20A, and the change in position of the end portion 151 is transmitted to the first transmission unit 31 and the second transmission unit 32, and thus, the first portion 21A moves along the x-axis. According to this, the positions of the feet of the user change in the x-axis direction without power supply, but the position of the center of gravity of the user hardly changes in the x-axis direction (front-back direction). This enables a user to stably perform the sitting motion and the standing motion, and to stably support the user in both the sitting posture and the standing posture.

In the stable support mechanism 10A, the sitting position Psit and the standing position Pstd of the end portion 151 and the optimum length of the link 15 can be designed based on an amount of the posture change of the second portion 22A and a desired amount of the translational movement of the support structure 20A along the x-axis.

Both the stable support mechanisms 10 and 10A can be used in a posture transition assist apparatus for rehabilitation, standing practice, or the like. The stable support mechanism 10 or 10A may be provided with a seat to be used as a special chair such as a chair for conferencing, a chair for reception work, or a dining chair for a person with weak leg strength. Wheels may be attached to the stable support mechanism 10, 10A, or the posture transition assist apparatus to which the stable support mechanism 10 or 10A is applied to be used as a mobile body such as a wheelchair. In the case of application to a wheelchair, it is possible to travel in a standing position or in a sitting position. By means of the link 15 having the fixed length, the posture change of the second portion of the support structure and the horizontal displacement of the first portion can be linked. This is safer also from the viewpoint of prevention of falling than a system in which the posture change and the horizontal displacement are controlled by using an electric motor or the like.

### <Application to Posture Transition Assist Apparatus>

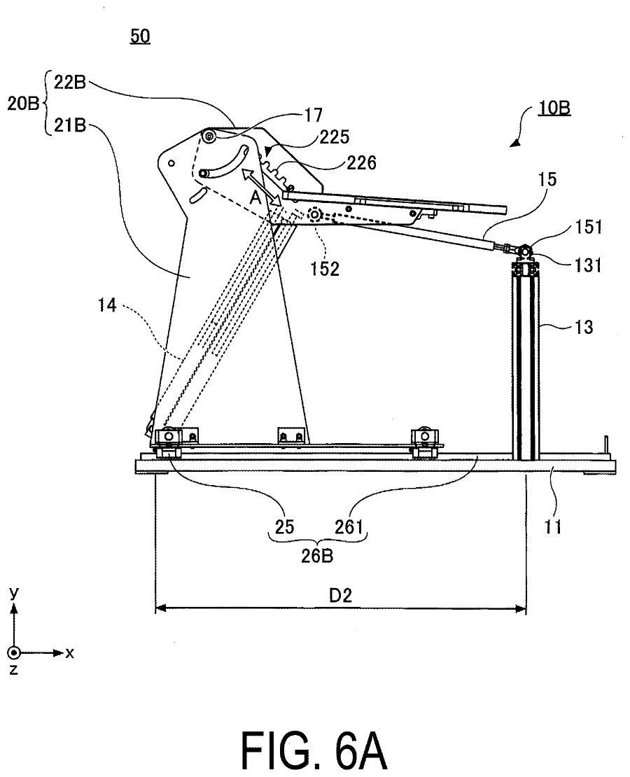

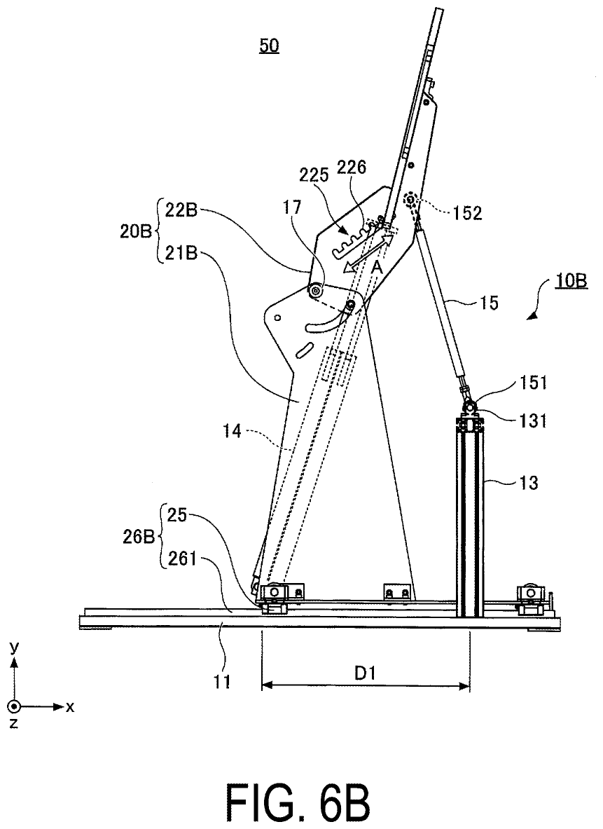

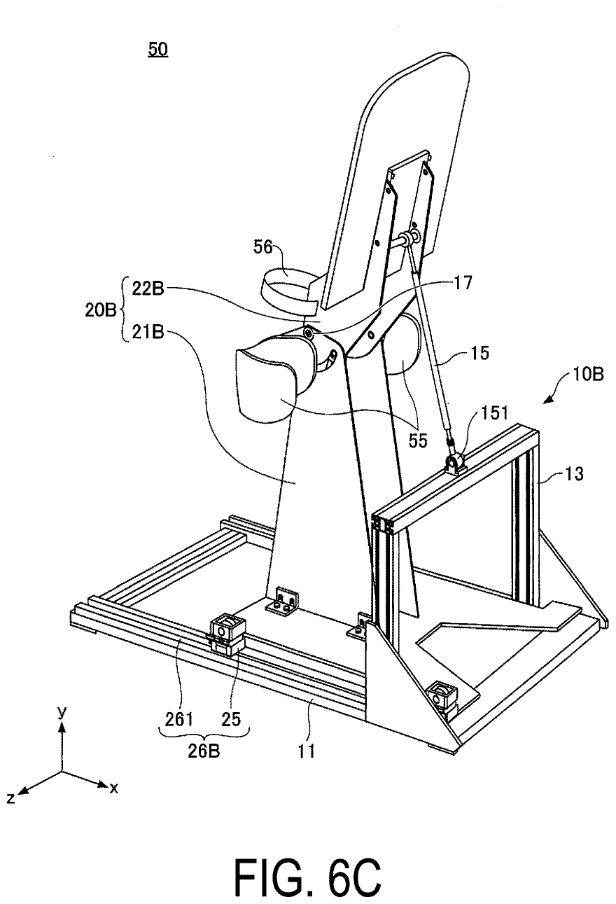

FIG. 6A to FIG. 6C illustrate an example in which a stable support mechanism 10B is applied to a posture transition assist apparatus 50. FIG. 6A is a side view illustrating the posture transition assist apparatus 50 in a sitting state, FIG. 6B is a side view illustrating the posture transition assist apparatus 50 in a standing state, and FIG. 6C is a diagram of the posture transition assist apparatus 50 in FIG. 6B as viewed obliquely from the back side. In the posture transition assist apparatus 50, the stable support mechanism 10B is provided with a passive actuator 14, a knee support 55, a fixture 56 (see FIG. 6C), and the like, but these members are not essential. A support structure 20B of the stable support mechanism LOB can slide on the base 11 in the x-axis direction without power supply with a simple configuration using the link 15 having a fixed length. The base 11 may include a link holder 13 that accurately holds a position of the end portion 151 of the link 15 determined from the calculation results in FIG. 4. In the example of FIG. 6C, the link holder 13 is formed by a frame having a gate shape, but is not limited to this example, and any structure capable of holding the end portion 151 of the link 15 at an appropriate position, such as an I-shape, an inverted U-shape, or an inverted Y-shape, can be adopted.

A slide rail 261 may be provided on the upper surface of the base 11 and thus, the support structure 20B is slid along the x-axis. The first portion 21B of the support structure 20B may be fixed to a slider 25 that slides on the slide rail 261. The slide rail 261 and the slider 25 constitute a mobile member 26B.

The first portion 21B slides on the base 11, but is not involved in posture change. The second portion 22B is connected to the first portion 21B by using the rotation shaft 17 and is involved in posture change. The second portion 22B may have a shape that supports the back sides of the thighs of the user, and may have a seat shape such as a square shape, a Y-shape, a U-shape, or a horseshoe shape. When the second portion 22B having a Y-shape or a U-shape is used, each of the two branches may be provided with the fixture 56 for fixing the thigh of the user. The fixture may be a belt, a harness, or the like that winds around the thighs of the user, or may be a plastic molded fastener to be latched.

The second portion 22B rotates around the rotation shaft 17 in conjunction with the motions of the knee joints of the user. In the sitting state in FIG. 6A, the second portion 22B is substantially parallel to the base 11 (at the first position). A tip position of the first portion 21B is positioned at a distance D2 from the link holder 13 of the base 11 (corresponding to the translational position T1 in FIG. 3A). In the standing state in FIG. 6B, the second portion 22B of the support structure 20B rises up substantially perpendicular to the base 11 in the +y direction (at the second position). At this time, the tip position of the first portion 21B is positioned at a distance D1 from the link holder 13 of the base 11 (corresponding to the translational position T2 in FIG. 3B). The distance D1 is shorter than the distance D2.

The passive actuator 14 may be used to assist driving of the second portion 22B in response to rotation of the knee joints of the user, that is, a standing motion or a sitting motion. The passive actuator 14 is set at a position that effectively induces posture change of the second portion 22B according to a load applied to the rotation shaft 17 due to a change in posture of the upper body of the user, and assists standing and sitting of the user. The passive actuator 14 also generates an assist force by using a weight of the user, and thus, does not need to be supplied with electric power.

One end portion of the passive actuator 14 is fixed to the first portion 21B of the support structure 20B and the other end portion thereof is fixed to a suitable point of the second portion 22B. Although a gas spring is used as the passive actuator 14 in the example in FIG. 6A to FIG. 6C, an appropriate elastic member such as a viscoelastic damper using liquid pressure, a coil spring, and a rubber spring may be used. An adjustment unit 225 may be provided in the second portion 22B, and thus, the assist force of the passive actuator 14 is adjusted. The assist force to be generated by the passive actuator 14 can be adjusted by selecting the position of a protrusion 226 for fixing the end portion of the passive actuator 14 to the second portion 22B along the two-way arrow A.

In the sitting state in FIG. 6A, the passive actuator 14 is compressed. When the user starts the standing motion, the upper body of the user tilts forward and a counterclockwise force is applied to the rotation shaft 17 of the stable support mechanism 10B. Assuming that a frictional force between the slide rail 261 and the slider 25 is ideally zero, the first portion 21B moves in the +x direction without the link 15. The link 15 guides the first portion 21B of the support structure 20B at a suitable speed by a suitable distance in the +x direction. The passive actuator 14 generates an assist moment that balances with a rising-up reaction force (load). As the rotation shaft 17 rotates counterclockwise and the second portion rises up in the +y direction, the load applied to the rotation shaft 17 decreases.

In sitting down from the state illustrated in FIG. 6B, a load is applied to the rotation shaft 17 by tilting the upper body backward when the user sits down, and at the same time, a force directed forward, that is, a force directed in the −x direction acts on the first portion 21B of the support structure 20B. Assuming that a frictional force between the slide rail 261 and the slider 25 is ideally zero, the first portion 21B moves in the −x direction without the link 15, but any frictional force actually acts. Further, when the link 15 is not provided, it is difficult to control a translation speed and a movement range of the first portion 21B. Providing the link 15 allows the first portion 21B to be stably guided in the direction along the x-axis according to the posture change of the second portion 22B. The passive actuator 14 generates an assist moment slightly lower than a load from the user in the entire process of the sitting motion, and thus, assists the sitting.

It goes without saying that the posture transition assist apparatus 50 may be configured by using the stable support mechanism 10 (in FIG. 3A and FIG. 3B) or the stable support mechanism 10A (in FIG. 5A and FIG. 5B). This is because, in both of the stable support mechanisms 10 and 10A, when the posture of the second portion 22 or 22A is changed according to the load applied to the rotation shaft 17, the first portion 21 or 21A can be stably moved in the x-axis direction by the link 15 having the fixed length.

### <Application to Posture Transition Assist Apparatus for Standing Practice or Rehabilitation>

Since the first portion 21B is translationally moved along the x-axis by using the link 15, rapid movement of the position of the center of gravity of the user is suppressed, and the user can perform standing-up and sitting-down training with a stable motion. The knee support 55 or the fixture 56 for fixing the thighs may be used to further increase the stability of the posture transition. By using the stable support mechanism 10B, the posture transition assist apparatus 50 suppresses movement of the center of gravity of the user in the front-back direction. Since the urging force in the motion of the posture transition, in particular, in the final phase of the standing motion is suppressed, the posture is stabilized, and the user can perform standing practice or the like without a sense of being thrown forward. It goes without saying that the stable support mechanism 10 or 10A may be applied to a posture transition assist apparatus for standing practice or rehabilitation. In this case, the knee support 55 and/or the fixture 56 may be provided in the stable support mechanism 10 or 10A as needed.

### <Application to Chair>

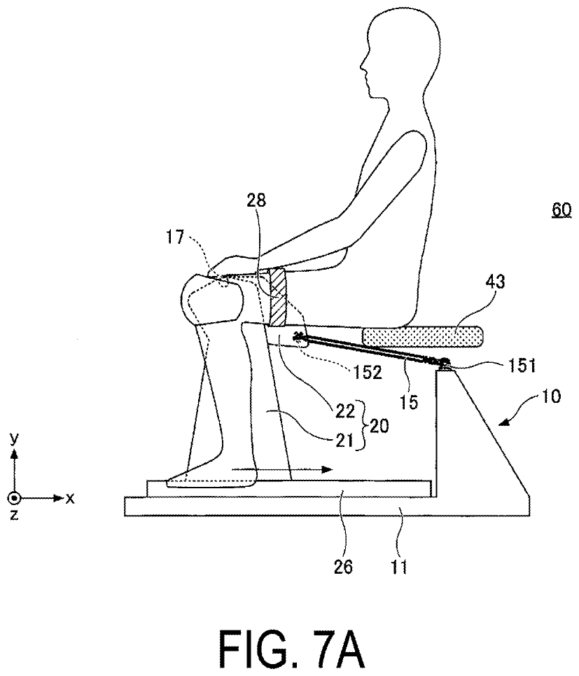

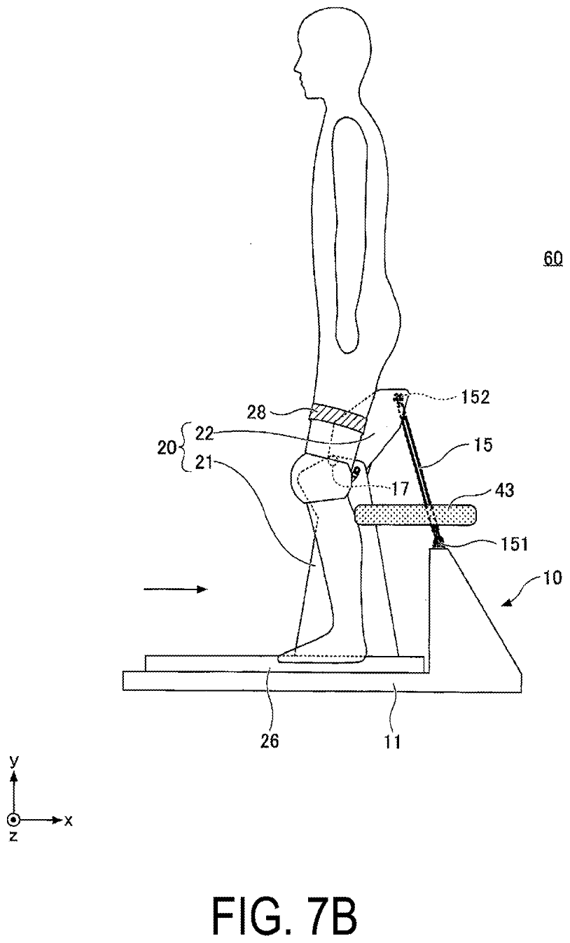

FIG. 7A and FIG. 7B illustrate an example of applying the stable support mechanism 10 to a chair 60. FIG. 7A illustrates a sitting state, and FIG. 7B illustrates a standing state. The chair 60 includes the stable support mechanism 10 and a seat 43. For example, the seat 43 may be fixed to the base 11 or may be attached to the first portion 21 of the support structure 20.

The second portion 22 of the support structure 20 may be provided with a fixture 28 for fixing the thighs of the user, but the fixture 28 is not essential. In FIG. 7A, the second portion 22 is positioned substantially horizontal to the base 11, and the link 15 is also substantially parallel to the base 11. The buttocks of the user are positioned on the seat 43.

In FIG. 7B, when the user stands up from the seat 43, the second portion 22 stands up in the +y direction. Along with the posture change of the second portion 22, the position of the end portion 152 of the link 15 moves, and the first portion 21 of the support structure 20 moves in the +x direction. As a result, the positions of the feet of the user move backward, and the position of the center of gravity of the user hardly changes in the front-back direction (see FIG. 2).

Since it is assumed that the chair 60 is to be used for a user who can stand up and sit down by himself/herself, the rotation of the second portion 22 and the horizontal movement of a first member are interlocked with each other only by using the link 15 having the fixed length. It goes without saying that the stable support mechanism 10A illustrated in FIG. 5A and FIG. 5B may be applied to the chair 60. When the chair is used as a special chair for a person with weak leg strength, the passive actuator 14 for support may be combined with the seat 43 as in the stable support mechanism 10B of the posture transition assist apparatus 50 illustrated in FIG. 6A to FIG. 6C. Also in this case, no power supply is required.

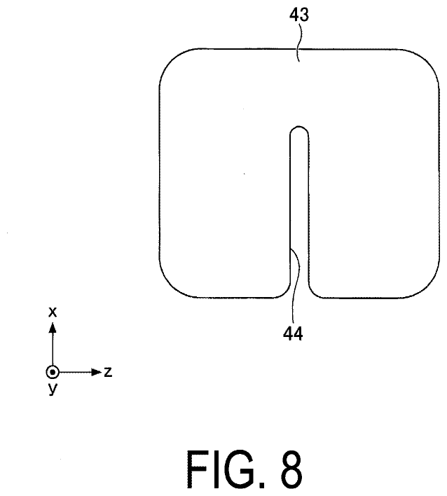

As illustrated in FIG. 8, a slit 44 through which the link 15 passes may be provided in the seat 43, and thus, the posture of the link 15 is changed according to the posture change of the second portion 22. When the stable support mechanism 10, 10A, or 10B is applied to a chair, the movement of the center of gravity of the user in the front-back direction is suppressed, and the user can stably and safely stand up and sit down. The feet of the user moves forward (in −x direction) during the sitting motion, and the feet of the user moves backward (in +x direction) during the standing motion. An amount of translational movement in the x-axis direction can be designed to be a desired amount according to the body shape of the user. When the positions of the feet slide in the x-axis direction (or the horizontal direction), the position of the center of gravity of the user in the x-axis direction is kept substantially constant.

### <Application to Mobile Apparatus>

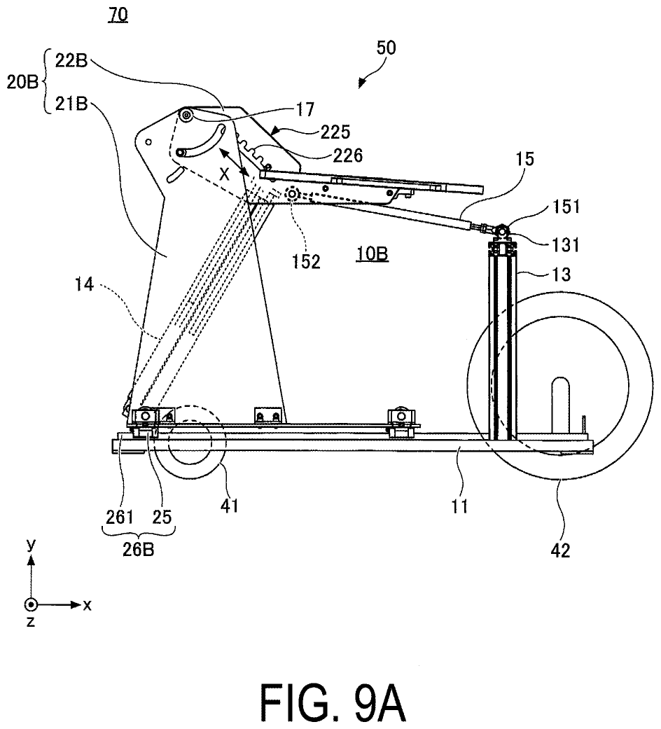

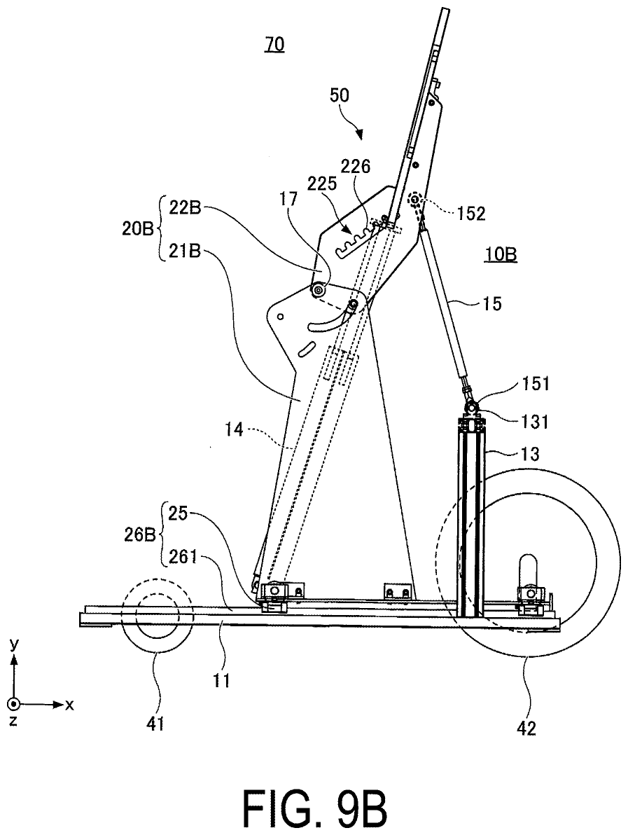

FIG. 9A and FIG. 9B respectively illustrate a sitting state and a standing state of a mobile apparatus 70 to which the stable support mechanism 10B is applied. The mobile apparatus 70 includes the stable support mechanism 10B and wheels 41 and 42. The wheel 41 may be used as a front wheel, and the wheel 42 may be used as a back wheel. Although the wheel 42 may be used as a main wheel and the wheel 41 may be used as a sub wheel, the wheels 41 and 42 having sizes similar to each other may be used.

A pair of wheels 41 may be disposed on both sides of the base 11 and one wheel 42 may be provided. The wheels 42 may also be disposed on both sides of the base 11. The entire stable support mechanism 10B including the base 11 may be mounted on a frame connecting the wheels 41 and 42. Although not illustrated, at least a driving mechanism and a braking mechanism for controlling the rotation of the wheel 42 may be provided. Further, a controller that controls a direction of the wheel 42 may be provided.

In the example in FIG. 9A and FIG. 9B, the stable support mechanism 10B is applied to the mobile apparatus 70 in the state of the posture transition assist apparatus 50 in FIG. 6A to FIG. 6C, but the present invention is not limited to this example. For a user who is difficult to walk but is capable of sitting and standing by himself/herself, the mobile apparatus may be configured by merely combining the wheels 41 and 42 with the stable support mechanism 10B. By using the stable support mechanism 10B, in addition to the stabilization of the entire apparatus including the user during movement at the sitting position or movement at the standing position, the posture transition in standing or sitting is also stabilized. It goes without saying that the stable support mechanism 10 in FIG. 3A and FIG. 3B and the stable support mechanism 10A in FIG. 5A and FIG. 5B may be applied to the mobile apparatus 70.

Although the present invention has been described above based on specific configuration examples, the present invention is not limited to the above-described configuration examples. The seat 43 may be used as a wheelchair by being incorporated in the mobile apparatus 70. Instead of the transmission unit 30 such as a belt, a chain, or a wire, a combination of gears may be used. Any configuration that achieves the translational movement while suppressing the movement of the center of gravity of the user in the front-back direction by using the link 15 having the fixed length may be adopted. Any transmission unit that converts rotation of the second portions 22, 22A and 22B into the translational movement may be used.

When the stable support mechanism 10, 10A, or 10B is fixed to the floor and is used for the posture transition assist apparatus 50 that assists standing practice or posture transition, a sense of being pushed forward when standing is suppressed, and training can be performed with ease. The chair 60 provided with the stable support mechanism 10, 10A, or 10B stabilizes the sitting motion and the standing motion, and the sitting posture and the standing posture while suppressing a change in position of the center of gravity of the user in the front-back direction. Thus, the chair 60 is useful as a seat for conference or the like, and also as a special chair for performing assembly work on a belt conveyor, medical surgery, or the like. In any case, the user can be stably supported through before and after the posture transition without power supply with a simple configuration using the link 15 having the fixed length.

This application claims priority to Patent Application No. 2020-193849 filed with the Japan Patent Office on Nov. 20, 2020, the entire contents of which are incorporated by reference.

### REFERENCE SIGNS LIST

10, 10A, 10B Stable support mechanism
11 Base
13 Link holder
14 Passive actuator
15 Link
151, 152 End portion
17 Rotation shaft
20, 20A, 20B Support structure
21, 21A, 21B First portion
22, 22A, 22B Second portion
25 Slider
26, 26B Mobile member
261 Slide rail
28, 56 Fixture
30 Transmission unit
31 First transmission unit
32 Second transmission unit
41, 42 Wheel
43 Seat
44 Slit
50 Posture transition assist apparatus
55 Knee support
60 Chair
70 Mobile apparatus
T1, T2 Translational position

1. A posture transition assist apparatus comprising:
a base;
a support structure mounted on the base, the support structure being configured to be capable of translational movement along a first axis in a plane horizontal to the base, the support structure being configured to be capable of changing a posture between a first position and a second position in a plane perpendicular to the base;
a link having a fixed length, one end of the link being connected to the base, the other end of the link being connected to the support structure, the link being configured to guide the support structure in a direction along the first axis along with changing the posture of the support structure;
a mobile member configured to translationally move the support structure between a front end and a back end of the base; and
a passive actuator configured to apply an assist force to changing the posture of the support structure without power supply, wherein
the support structure includes a first portion whose posture is not configured to be changed, the first portion being attached to the mobile member, and a second portion whose posture is configured to be changed, the second portion being rotatably connected to the first portion,
one end portion of the passive actuator is fixed to the first portion of the support structure,
the other end portion of the passive actuator is fixed to the second portion of the support structure,
the other end of the link is connected to the second portion of the support structure, and
when the second portion changes the posture from the first position to the second position, and supports a standing motion of a user, the first portion translationally moves toward a side of the back end of the base by an action of the link, and an axis about which the second portion rotates is at substantially the same position as a position of a knee joint of the user.

2-3. (canceled)

4. The posture transition assist apparatus according to claim 1, wherein
the mobile member is a slide rail provided on the base, and
the first portion of the support structure includes a slider configured to move on the slide rail.

5. The posture transition assist apparatus according to claim 1, further comprising:
a first transmission unit suspended between a side of the front end of the base and the first portion of the support structure; and
a second transmission unit suspended between a side of the back end of the base and the first portion of the support structure,
wherein the first transmission unit and the second transmission unit move the first portion along the first axis when the posture change of the support structure is transmitted by the link.

6. The posture transition assist apparatus according to claim 1, wherein the second portion of the support structure includes a fixture configured to fix a thigh of a user.

7. The posture transition assist apparatus according to claim 1, wherein
the first position is a position corresponding to a sitting posture,
the second position is a position corresponding to a standing posture, and
movement of a center of gravity of the user in a front-back direction is suppressed by the link in the posture change between the first position and the second position.

8. (canceled)

9. A chair comprising:
the posture transition assist apparatus according to claim 1; and
a seat,
wherein the seat includes a slit through which the link passes.

10. A mobile apparatus comprising:
the posture transition assist apparatus according to claim 1; and
a wheel attached to the posture transition assist apparatus.

11. The posture transition assist apparatus according to claim 1, wherein the base includes a link holder configured to hold the one end of the link and the one end of the link is connected to the link holder.
